(19) United States
(12) Patent Application Publication
(10) Pub. No.: US 2024/0312378 A1
(43) Pub. Date: Sep. 19, 2024

(54) PROJECTOR, PROJECTION METHOD, AND NON-TRANSITORY COMPUTER-READABLE STORAGE MEDIUM STORING PROGRAM

(71) Applicant: SEIKO EPSON CORPORATION, Tokyo (JP)

(72) Inventors: Jun YOSHIMURA, HIJI-MACHI (JP); Genta KAWABE, MATSUMOTO-SHI (JP)

(21) Appl. No.: 18/603,689

(22) Filed: Mar. 13, 2024

(30) Foreign Application Priority Data
Mar. 14, 2023 (JP) 2023-039396

(51) Int. Cl. G09G 3/00; G09G 3/36; H04N 9/31

(52) U.S. Cl. CPC G09G 3/002; G09G 3/3607; G09G 2340/0442; G09G 2354/00; H04N 9/3138

(57) ABSTRACT

A projection method includes projecting, in a first mode, a third image including a first image having a first size and a second image arranged along a contour of the first image on an outer side of the first image; and projecting, in a second mode, the first image in a second size larger than the first size.

The present application is based on, and claims priority from JP Application Serial Number 2023-039396, filed Mar. 14, 2023, the disclosure of which is hereby incorporated by reference herein in its entirety.

### BACKGROUND

### 1. Technical Field

The present disclosure relates to a projector, a projection method, and a non-transitory computer-readable storage medium storing a program.

### 2. Related Art

There has been known a technique for providing an image suited to the taste of a user.

For example, JP-A-2013-109239 (Patent Literature 1) discloses an image display apparatus including an image display and a picture frame section located in the periphery of the image display, the image display apparatus being configured to be capable of variably controlling the width of the picture frame section. The picture frame section includes a non-image display region that surrounds the image display and a frame section that surrounds the non-image display region. The width of the picture frame section is variably controlled by changing the width of the non-image display region.

However, the image display apparatus disclosed in Patent Literature 1 cannot change a position and a shape of the frame section because of the structure of the image display apparatus. Therefore, flexibility of rendering that can be performed on an image displayed by the image display has not been high.

### SUMMARY

According to an aspect of the present disclosure, there is provided a projector including: an optical device; and at least one processor. The at least one processor operates in a first mode for controlling the optical device to thereby project a third image including a first image having a first size and a second image arranged along a contour of the first image on an outer side of the first image and a second mode for controlling the optical device to thereby project the first image in a second size larger than the first size.

According to an aspect of the present disclosure, there is provided a projection method including: projecting, in a first mode, a third image including a first image having a first size and a second image arranged along a contour of the first image on an outer side of the first image; and projecting, in a second mode, the first image in a second size larger than the first size.

According to an aspect of the present disclosure, there is provided a non-transitory computer-readable storage medium storing a program, the program causing a computer to execute: projecting, in a first mode, a third image including a first image having a first size and a second image arranged along a contour of the first image on an outer side of the first image; and projecting, in a second mode, the first image in a second size larger than the first size.

### BRIEF DESCRIPTION OF THE DRAWINGS

FIG. 1 is a block diagram showing a configuration of a projector.

FIG. 2 is a diagram showing an example of a content image.

FIG. 3 is a diagram showing an example of a decoration image.

FIG. 4 is a diagram showing an example of a combined image.

FIG. 5 is a diagram showing another example of the decoration image.

FIG. 6 is a diagram showing a projection image on which a first UI image is displayed.

FIG. 7 is a diagram showing a projection image on which a combined image is displayed in a content region.

FIG. 8 is a diagram showing a projection image in which a part of a UI region is superimposed on the content region.

FIG. 9 is a flowchart showing an operation of the projector.

FIG. 10 is a flowchart showing an operation of the projector.

FIG. 11 is a diagram showing another example of the decoration image.

FIG. 12 is a diagram showing a projection image obtained by combining the decoration image shown in FIG. 11 with a content image.

FIG. 13 is a diagram showing a projection image including a second UI image.

FIG. 14 is a diagram showing a projection image including a second UI image.

FIG. 15 is a diagram showing the projection image in which a display position of the content image is moved in the upward direction.

FIG. 16 is a diagram showing the projection image in which a display position of the decoration image is moved in the upward direction.

FIG. 17 is a diagram showing a projection image including a second UI image.

FIG. 18 is a diagram showing the projection image in which a display size of the decoration image is reduced.

FIG. 19 is a diagram showing the projection image in which a display size of the content image is enlarged.

### DESCRIPTION OF EMBODIMENTS

An embodiment of the present disclosure is explained below with reference to the drawings.

### 1. Configuration of a Projector

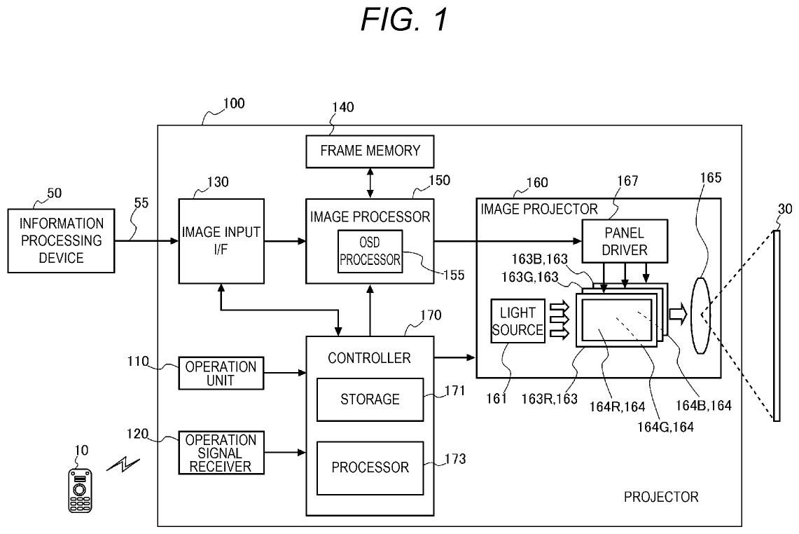

FIG. 1 is a block diagram showing a configuration of a projector 100.

The configuration of the projector 100 is explained with reference to FIG. 1.

The projector 100 includes an operation unit 110, an operation signal receiver 120, an image input interface 130, a frame memory 140, an image processor 150, an image projector 160, and a controller 170. In the following explanation, interface is abbreviated as I/F.

The operation unit 110 includes a plurality of operation keys. A user operates the operation keys of the operation unit 110 to input various instructions to the projector 100. When the user operates an operation key of the operation unit 110, the operation unit 110 outputs an operation signal corresponding to the operated operation key to the controller 170. The operation keys included in the operation unit 110 include a power key for switching power on and off, a menu key for displaying a menu for performing various kinds of setting, direction keys for selecting an item of the menu, and an enter key for determining operation.

The operation signal receiver 120 is a reception device for an infrared signal and includes a light receiving element, a decoder, and the like not shown in FIG. 1. The operation signal receiver 120 receives and decodes an infrared signal transmitted from a remote controller 10. The operation signal receiver 120 decodes the infrared signal and outputs an operation signal corresponding to an operated operation key or an operated button of the remote controller 10 to the controller 170. The operation signal receiver 120 may receive a radio signal of Bluetooth or the like from the remote controller 10. Bluetooth is a registered trademark. When the operation signal receiver 120 is configured to receive the radio signal, the operation signal receiver 120 may include an antenna and a reception circuit. The operation unit 110 and the operation signal receiver 120 can be referred to as operation input I/F as well.

The remote controller 10 includes a plurality of operation keys that are the same as the operation keys of the operation unit 110. For example, the remote controller 10 includes a menu key for displaying a menu for performing various kinds of setting, direction keys for selecting an item of the menu, and an enter key for determining operation. The remote controller 10 includes a first change button for changing a display mode to a first mode or a second mode and a second change button for changing a decoration image 300 to be combined with an input image supplied from an information processing device 50. Further, the remote controller 10 includes a third change button for changing display positions and display sizes of the input image and the decoration image 300. The input image, the decoration image 300, the first mode, and the second mode are explained below. The remote controller 10 may be a portable terminal such as a smartphone. In this case, I/F images of the operation keys are displayed on a touch panel of the portable terminal by application software installed in the portable terminal.

The image input I/F 130 includes a connector and an interface circuit and is connected to the information processing device 50 by wire via a cable 55. The information processing device 50 is an external device that supplies an image signal to the projector 100. For example, a personal computer of a desktop type, a notebook type, a tablet type, or the like or a smartphone is used as the information processing device 50. The image input I/F 130 extracts an input image included in the image signal received via the cable 55 and outputs the extracted input image to the image processor 150. For example, an HDMI (High-Definition Multimedia Interface) is used as the image input I/F 130. HDMI is a registered trademark. In this embodiment, a case in which a connection form of the information processing device 50 and the projector 100 is wired is explained. However, the connection form of the information processing device 50 and the projector 100 may be wireless.

The frame memory 140 is connected to the image processor 150. The image processor 150 includes an OSD (On Screen Display) processor 155.

The image processor 150 loads an input image input from the information processing device 50 in the frame memory 140.

The OSD processor 155 superimposes, based on control of the controller 170, an OSD image on the input image loaded in the frame memory 140. The OSD image includes a first user interface image 540 and a second user interface image 600 explained below. In the following explanation, user interface is abbreviated as UI. The OSD processor 155 includes a not-shown OSD memory. The OSD memory stores OSD image information representing a figure, a font, and the like for forming the OSD image. When instructed to superimpose the OSD image by the controller 170, the OSD processor 155 reads out a necessary OSD image from the OSD memory and superimposes the OSD image on the input image loaded in the frame memory 140.

The image processor 150 performs, on an image loaded in the frame memory 140, image processing such as resolution conversion processing, resize processing, correction of a distortion aberration, shape correction processing, digital zoom processing, or adjustment of a tint and luminance of an image. The image loaded in the frame memory 140 is the input image or an image obtained by superimposing the OSD image on the input image.

The image processor 150 outputs image information, which is information concerning the image loaded in the frame memory 140, to a panel driver 167 of the image projector 160.

The frame memory 140 and the image processor 150 are configured by, for example, an integrated circuit. The integrated circuit includes an LSI (Large Scale Integrated Circuit), an ASIC (Application Specific Integrated Circuit), a PLD (Programmable Logic Device), an FPGA (Field-Programmable Gate Array), and an SoC (System-on-a-chip). In the frame memory 140 and the image processor 150, an analog circuit may be included in a part of the configuration of the integrated circuit. The controller 170 and the integrated circuit may be combined.

The image projector 160 includes a light source 161, three liquid crystal panels 163R, 163G, and 163B functioning as a light modulation device, a projection lens 165 functioning as an optical system unit, and the panel driver 167. In the following explanation, when the liquid crystal panels 163R, 163G, and 163B are collectively referred to, the liquid crystal panels 163R, 163G, and 163B are described as liquid crystal panels 163. The liquid crystal panels 163 are equivalent to the display panel. The light source 161, the liquid crystal panels 163R, 163G, and 163B, and the projection lens 165 included in the image projector 160 are equivalent to the optical device.

The light source 161 includes a solid-state light source such as a light emitting diode or a semiconductor laser. As the light source 161, a light source lamp of a discharge type such as an ultrahigh pressure mercury lamp or a metal halide lamp may be used. Light emitted by the light source 161 according to an instruction of the controller 170 is converted into light having a substantially uniform luminance distribution by a not-shown integrator optical system and is separated into color light components of red (R), green (G), and blue (B) by a not-shown color separation optical system. Thereafter, lights separated into the color light components of red (R), green (G), and blue (B) are respectively made incident on the liquid crystal panels 163R, 163G, and 163B. The lights separated into the color light components made incident on the liquid crystal panels 163R, 163G, and 163B are referred to as color lights.

Each of the liquid crystal panels 163R, 163G, and 163B is configured by, for example, a transmissive liquid crystal panel in which liquid crystal is encapsulated between a pair of transparent substrates. In the liquid crystal panels 163, rectangular image forming regions 164R, 164G, and 164B including pluralities of pixels arrayed in a matrix are formed. A driving voltage can be applied to each of the pixels.

The panel driver 167 forms images in the image forming regions 164R, 164G, and 164B of the liquid crystal panels 163R, 163G, and 163B. Specifically, the panel driver 167 applies, according to an instruction of the controller 170, a driving voltage corresponding to image information input from the image processor 150 to the pixels of the image forming regions 164R, 164G, and 164B and sets the pixels to light transmittance corresponding to the image information. Light emitted from the light source 161 is transmitted through the image forming regions 164R, 164G, and 164B of the liquid crystal panels 163R, 163G, and 163B to be modulated for each of the pixels. Image lights corresponding to the image information are formed for each of the color lights. The formed color image lights are combined for each of the pixels by a not-shown color combination optical system to be image light representing a color image and are enlarged and projected onto a screen 30, which is a projection surface, by the projection lens 165. In this embodiment, the projection surface is the screen 30. However, a wall surface or a ceiling in a room, an outdoor external wall, and the like can also be used as the projection surface.

The controller 170 includes a storage 171 and a processor 173.

The storage 171 includes a volatile storage device and a nonvolatile storage device.

The volatile storage device is configured by, for example, a RAM (Random Access Memory). The nonvolatile storage device is configured by, for example, a ROM (Read Only Memory), a flash memory, or an EEPROM (Electrically erasable Programmable Read-Only Memory). The volatile storage device is used as an arithmetic region of the processor 173.

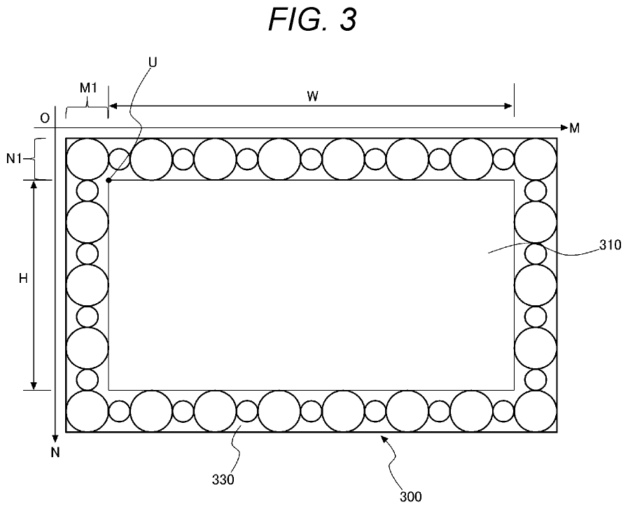

The nonvolatile memory stores a control program to be executed by the processor 173, the decoration image 300, and arrangement information. Details of the decoration image 300 and the arrangement information are explained below with reference to FIG. 3. The decoration image 300 is equivalent to the second image.

The processor 173 is an arithmetic processing device including a processor such as a CPU (Central Processing Unit) or an MPU (Micro-Processing Unit). The processor 173 may be configured by a single processor or can also be configured by a plurality of processors. The processor 173 may be configured by an SoC integrated with a part or the entire storage 171 and other circuits. The processor 173 may be configured by a combination of a CPU that executes a program and a DSP (Digital Signal Processor) that executes predetermined arithmetic processing. Further, all of functions of the processor 173 may be implemented on hardware. The processor 173 may be configured using a programmable device.

### 2. Operation of the Projector

In the following explanation, the projector 100 projecting image light onto the screen 30 and forming an image on the screen 30 is referred to as display. An image displayed on the screen 30 by the projector 100 is referred to as projection image 500. An input image included in an image signal received from the information processing device 50 by the projector 100 is referred to as content image 200. In the following explanation, the user operates the remote controller 10 to cause the projector 100 to execute processing. The user can also operate the operation unit 110 to cause the projector 100 to execute the same processing.

The projector 100 includes a first mode and a second mode as a display mode for displaying an image on the screen 30.

In the first mode, the projector 100 combines the decoration image 300 with the content image 200 included in the image signal received from the information processing device 50 to thereby generate a combined image 400. In the first mode, the projector 100 displays image light based on the generated combined image 400 on the screen 30. The content image 200 is equivalent to the first image. The combined image 400 is equivalent to the third image.

In the second mode, the projector 100 displays the content image 200 included in the image signal received from the information processing device 50 on the screen 30. The projector 100 operating in the second mode does not perform an operation for combining the decoration image 300 with the content image 200. When operating in the second mode, the projector 100 generates image light based on the content image 200 and displays the generated image light on the screen 30.

A size of the entire combined image 400 displayed by the projector 100 in the first mode and a size of the content image 200 displayed by the projector 100 in the second mode are the same second size. The content image 200 is included in the combined image 400 in the first mode. Therefore, a size of the content image 200 displayed in the first mode is smaller than the size of the content image 200 displayed in the second mode. In other words, in the first mode, the projector 100 displays the content image 200 on the screen 30 in the first size. In the second mode, the projector 100 displays the content image 200 in the second size. The second size is larger than the first size.

A size of an image explained in this embodiment is not a size in a real space formed on the screen 30 by image light but is a size of an image in processing executed by the image processor 150. That is, the size of the image is, for example, the number of pixels forming the image and can be referred to as the resolution of the image as well. As explained above, the image processor 150 performs image processing such as resolution conversion processing, resize processing, shape correction processing, or digital zoom processing. The first size and the second size are the numbers of pixels or the resolutions of the image in a state before the image processor 150 applies the image processing explained above to the image. The first size and the second size are examples of the numbers of pixels and the resolutions of the image. Therefore, the first size and the second size do not always coincide with the resolution of an image formed on the frame memory 140 by the image processor 150. Similarly, the first size and the second size do not always coincide with the resolution of images drawn on the liquid crystal panels 163.

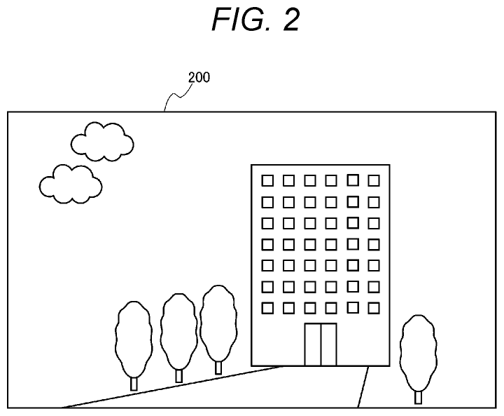

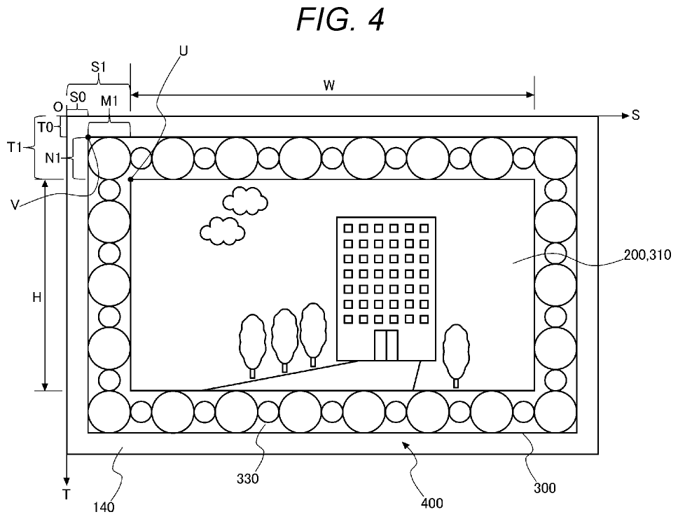

FIG. 2 is a diagram showing an example of the content image 200. FIG. 3 is a diagram showing an example of the decoration image 300. FIG. 4 is a diagram showing an example of the combined image 400.

The content image 200 is an image included in an image signal supplied to the projector 100 by the information processing device 50 as explained above and may be a moving image or may be a still image.

The decoration image 300 is, for example, an image stored in advance in the storage 171 of the projector 100 and is an image that can be combined with various content images 200. The decoration image 300 may be stored in the storage 171 as a so-called template. The projector 100 may store a plurality of decoration images 300 in the storage 171. The projector 100 may download the decoration image 300 from, for example, a not-shown server device. The projector 100 may be configured to read out the decoration image 300 stored in an external storage such as a USB (Universal Serial Bus) memory or an SD card from the storage device and use the decoration image 300.

The decoration image 300 is, for example, a rectangular image and includes an arrangement section 310 and a picture frame section 330.

The arrangement section 310 is located in the center of the decoration image 300. The picture frame section 330 is arranged in the entire periphery of the arrangement section 310 along the contour of the arrangement section 310. The arrangement section 310 is a region where the content image 200 is arranged when the combined image 400 is generated. The image processor 150 superimposes the content image 200 on the arrangement section 310 of the decoration image 300 loaded in the frame memory 140. At this time, the picture frame section 330 is arranged along the contour of the content image 200 on the outer side of the content image 200.

The picture frame section 330 is a region where an image for decoration that decorates the content image 200 arranged in the arrangement section 310 is formed. The image formed in the picture frame section 330 is different in each of the plurality of decoration images 300. That is, exteriors of the plurality of decoration images 300 are different from one another.

In FIG. 3, an example of the decoration image 300, in the entire periphery of which the picture frame section 330 is formed is shown. However, the picture frame section 330 may be formed on upper and lower sides, left and right sides, or any one, two, or three of the upper, lower, left, and right sides of the rectangular decoration image 300.

The decoration image 300 includes arrangement information that is information indicating a position and a range in which the content image 200 is arranged on the inside of the decoration image 300. The arrangement information includes start point information and width and height information.

For example, a coordinate system is set in the decoration image 300. In FIG. 3, a coordinate system in which an upper left vertex O of the decoration image 300 is set as an origin, a coordinate in the lateral direction of the decoration image 300 is set as an M axis, and a coordinate in the longitudinal direction of the decoration image 300 is set as an N axis is shown. In the following explanation, the coordinate system set in the decoration image 300 is explained as an MN coordinate system.

The start point information is coordinate information indicating the position of a start point serving as a reference at the time when the content image 200 is arranged in the arrangement section 310. In this embodiment, an upper left vertex U of the arrangement section 310 is set as the start point in a drawing view. A coordinate of the vertex U in the MN coordinate system is described as (M1, N1).

Width information is information indicating width W in the M-axis direction from the vertex U set as the start point. Height information is information indicating height H in the N-axis direction from the vertex U set as the start point.

When the first mode is selected as the display mode by operation of the remote controller 10 by the user, the controller 170 instructs the image processor 150 to change the display mode to the first mode.

Subsequently, when the decoration image 300 to be combined with the content image 200 is selected by operation of the remote controller 10 by the user, the controller 170 reads out the selected decoration image 300 and arrangement information of the decoration image 300 from the storage 171. The controller 170 outputs the read-out decoration image 300 and the read-out arrangement information to the image processor 150.

When the decoration image 300 and the arrangement information is input from the controller 170, the image processor 150 loads the input decoration image 300 in the frame memory 140.

Subsequently, the image processor 150 executes reduction processing.

As explained above, the size of the content image 200 input to the image processor 150 from the image input I/F 130 is the second size, which is the same as the size of the combined image 400, and is larger than a size of the arrangement section 310 of the decoration image 300. Therefore, the image processor 150 executes the reduction processing for reducing, according to the size of the arrangement section 310, the content image 200 input from the image input I/F 130.

First, the image processor 150 compares the resolution of the content image 200 input from the image input I/F 130 and the width and height information included in the arrangement information and calculates a reduction ratio for reducing the content image 200. As an example, the reduction ratio is a ratio of resolution equivalent to the width W and the height H to the resolution of the content image 200. However, a calculation method for the reduction ratio is not limited to this.

After determining the reduction ratio, the image processor 150 executes the reduction processing for reducing the content image 200 at the determined reduction ratio.

Subsequently, the image processor 150 executes combination processing.

FIG. 4 shows the combined image 400 loaded in the frame memory 140. The combined image 400 shown in FIG. 4 is an example in which image processing such as shape correction is not applied to the combined image 400 by the image processor 150.

For example, a coordinate system is set in the frame memory 140. In FIG. 4, a coordinate system in which an upper left vertex O of the frame memory 140 is set as an origin, a coordinate in the lateral direction of the frame memory 140 is set as an S axis, and a coordinate in the longitudinal direction of the frame memory 140 is set as a T axis in a drawing view is shown. In the following explanation, the coordinate system set in the frame memory 140 is explained as an ST coordinate system.

The image processor 150 superimposes the content image 200 reduced by the reduction processing on the decoration image 300 to thereby generate the combined image 400 in the frame memory 140. In order to store the entire combined image 400 in the frame memory 140, the image processor 150 generates the combined image 400 having a size equal to or smaller than a maximum size of an image that can be loaded in the frame memory 140. The maximum size of the image that can be loaded in the frame memory 140 is the same as a maximum size of an image that can be drawn in the image forming regions 164 of the liquid crystal panels 163. That is, the second size, which is the size of the combined image 400, is the same as the maximum size of the image that can be loaded in the frame memory 140 or smaller than the maximum size. The second size is the same as the maximum size of the image that can be drawn in the image forming regions 164 or smaller than the maximum size. By setting the second size smaller than the maximum size of the image that can be drawn in the image forming regions 164, it is possible to change a position and a shape of the combined image 400 drawn on the liquid crystal panels 163 and change an enlarged or reduced size. Therefore, it is possible increase flexibility of the combined image 400 displayed on the screen 30 and improve convenience of the user.

In FIG. 4, it is assumed that a coordinate of an upper left vertex V of the decoration image 300 already loaded in the frame memory 140 is (S0, T0). The image processor 150 calculates, as an S coordinate value in the ST coordinate system of the vertex U, a coordinate value S1 obtained by adding the coordinate value M1 of the M coordinate of the start point information included in the arrangement information to SO, which is the S coordinate value of the upper left vertex V of the decoration image 300.

Similarly, the image processor 150 calculates, as a T coordinate value in the ST coordinate system of the vertex U, a coordinate value T1 obtained by adding the coordinate value N1 of the N coordinate of the start point information included in the arrangement information to T0, which is the T coordinate value of the upper left vertex V of the decoration image 300.

Subsequently, the image processor 150 superimposes, based on the arrangement information and the coordinate values in the ST coordinate system of the vertex U, the content image 200 reduced by the reduction processing on the arrangement section 310 of the decoration image 300 loaded in the frame memory 140.

The image processor 150 superimposes the content image 200 on the arrangement section 310 of the decoration image 300 loaded in the frame memory 140 to generate the combined image 400 such that the upper left vertex of the content image 200 is located in a coordinate in the ST coordinate system of the vertex U. An image of the arrangement section 310 of the decoration image 300 loaded in the frame memory 140 is rewritten into the content image 200 before the content image 200 is superimposed.

Therefore, the content image 200 is loaded in a region of the frame memory 140 where the arrangement section 310 of the decoration image 300 is loaded. An image of the picture frame section 330 is left in the frame memory 140 as it is. In this processing, the combined image 400 is generated such that the picture frame section 330 of the decoration image 300, which is the second image, does not overlap the content image 200, which is the first image.

In the combined image 400 generated in the frame memory 140, a region where the content image 200 is loaded is equivalent to the first region. In the combined image 400 generated in the frame memory 140, a region where the picture frame section 330 of the decoration image 300 is loaded is equivalent to the second region.

After generating the combined image 400, the image processor 150 may perform, on the generated combined image 400, image processing such as resolution conversion processing, resize processing, correction of a distortion aberration, shape correction processing, digital zoom processing, or adjustment of a tint and luminance of an image. These kinds of image processing are not essential processing. The image processor 150 may not execute the image processing described above. The image processor 150 may execute a plurality of kinds of image processing in combination out of the kinds of image processing described above.

When the image processing ends, the image processor 150 reads out image information of the combined image 400 loaded in the frame memory 140 and outputs the read-out image information to the panel driver 167 of the image projector 160.

When the image information is input from the image processor 150, the image projector 160 applies a driving voltage corresponding to the input image information to the pixels of the image forming regions 164R, 164G, and 164B and sets the pixels to light transmittance corresponding to the image information. Light emitted from the light source 161 is separated into R, G, and B color lights by the color separation optical system and transmitted through the image forming regions 164R, 164G, and 164B of the liquid crystal panels 163R, 163G, and 163B. Consequently, the color lights are modulated for each of the pixels and image lights corresponding to the image information are generated for each of the color lights. The formed color image lights are combined by the not-shown color combination optical system for each of the pixels to be image light representing a color image and enlarged and projected onto the screen 30, which is the projection surface, by the projection lens 165. At this time, the combined image 400 displayed on the screen 30 is displayed on the screen 30 such that the picture frame section 330 of the decoration image 300 and the content image 200 do not overlap.

The image processor 150 can generate the combined image 400 even if an aspect ratio of the arrangement section 310 and an aspect ratio of the content image 200 are different. Processing in this case is explained. The aspect ratio of the arrangement section 310 is equivalent to the aspect ratio of the first region. The aspect ratio of the content image 200 is equivalent to the aspect ratio of the first image.

When both of the content image 200 and the arrangement section 310 are rectangles, the aspect ratio of the content image 200 and the aspect ratio of the arrangement section 310 not coinciding means that the size of the content image 200 subjected to the reduction processing and the size of the arrangement section 310 do not coincide. The sizes not coinciding means that, for example, at least one of inconsistency of the numbers of pixels in the vertical direction and inconsistency of the numbers of pixels in the horizontal direction has occurred.

In this case, in the combined image 400 generated by directly superimposing the content image 200 subjected to the reduction processing on the decoration image 300, a part of the picture frame section 330 is sometimes erased by the content image 200 overlapping the picture frame section 330. In the generated combined image 400, a margin region, which is the outer side of the content image 200, is formed in the arrangement section 310.

The controller 170 designates an aspect ratio to the image processor 150. That is, when the aspect ratio of the arrangement section 310 and the aspect ratio of the content image 200 are different, the controller 170 instructs the image processor 150 which of the aspect ratios is selected. For example, the controller 170 selects the aspect ratio selected by the user and outputs an instruction indicating the selected aspect ratio to the image processor 150.

For example, when the aspect ratio of the arrangement section 310 is selected by the controller 170, the image processor 150 changes the aspect ratio of the content image 200 such that the aspect ratio of the content image 200 input to the image processor 150 coincides with the aspect ratio of the arrangement section 310. Thereafter, the image processor 150 performs reduction processing for reducing the content image 200, the aspect ratio of which is converted, while maintaining the aspect ratio and superimposes the reduced content image 200 on the arrangement section 310 of the decoration image 300 loaded in the frame memory 140.

When the aspect ratio of the content image 200 is selected by the controller 170, the image processor 150 changes the shape of the decoration image 300 such that the aspect ratio of the arrangement section 310 of the decoration image 300 coincides with the aspect ratio of the content image 200. Thereafter, when the content image 200 is input from the image input I/F 130, the image processor 150 reduces the input content image 200 with the reduction processing. The image processor 150 superimposes the reduced content image 200 on the arrangement section 310 of the decoration image 300 loaded in the frame memory 140.

When any one of the kinds of processing explained above is performed, in the combined image 400, the size of the arrangement section 310 and the size of the content image 200 coincide. Therefore, even if the aspect ratio of the arrangement section 310 and the aspect ratio of the content image 200 are different, the picture frame section 330 and the content image 200 do not overlap. The combined image 400 can be generated without forming a margin. Note that, when the aspect ratio of the content image 200 is selected, the shape of the decoration image 300 may not be changed. In this case, the image processor 150 reduces the content image 200 to size fit in the arrangement section 310 and arranges the content image 200 in the arrangement section 310 while maintaining the aspect ratio of the content image 200. The image processor 150 colors a margin region formed between at least one side of the content image 200 and at least one side of the picture frame section 330 in black.

Next, a case in which an operation of the projector 100 is set to the second mode by operation of the user is explained.

When the second mode is selected by the operation of the user, the controller 170 instructs the image processor 150 to change the display mode to the second mode.

When the controller 170 instructs the image processor 150 to change the display mode to the second mode and the content image 200 having the second size is input to the image processor 150 from the image input I/F 130, the image processor 150 loads the input content image 200 in the frame memory 140. The image processor 150 may perform, on the content image 200 loaded in the frame memory 140, image processing such as resolution conversion processing, resize processing, correction of a distortion aberration, shape correction processing, digital zoom processing, or adjustment of a tint and luminance of an image. These kinds of image processing are not essential processing as in the case of the first mode.

When the image processing ends, the image processor 150 reads out the image information of the combined image 400 loaded in the frame memory 140 and outputs the read-out image information to the panel driver 167 of the image projector 160. Since the following operation is the same as the operation in the first mode, explanation of the operation is omitted.

In the above explanation, the decoration image 300 includes the arrangement information. However, the decoration image 300 may not include the arrangement information. In this case, the arrangement section 310 of the decoration image 300 can be distinguished from a portion other than the arrangement section 310 in the decoration image 300, that is, the picture frame section 330. For example, the decoration image 300 includes the arrangement section 310 painted out by specific one color such as black.

After loading the decoration image 300 input from the controller 170 in the frame memory 140, the image processor 150 detects a region formed in the specific one color such as black from the decoration image 300. When detecting the region formed in the specific one color, the image processor 150 determines that the detected region is a region on which the content image 200 is superimposed. The region is referred to as superimposition region. The image processor 150 compares a size of the determined superimposition region and a size of the content image 200 and determines a reduction ratio for reducing the content image 200. The image processor 150 reduces the content image 200 at the determined reduction ratio and superimposes the reduced content image 200 on the superimposition region formed in the specific one color of the decoration image 300.

The decoration image 300 may be an image in which transmittance information is set in the arrangement section 310 instead of the arrangement information. In this case, for example, the transmittance information is set for each of the pixels of the decoration image 300 or for each of preset regions. The transmittance of the region corresponding to the arrangement section 310 explained above is set to 100%. The region, the transmittance of which is set to 100%, is a region where, when the region is superimposed on another image, the other image is displayed as it is. A region, the transmittance of which is set to 0%, is a region where, when the region is superimposed on another image, the other image is not displayed.

After loading the decoration image 300 input from the controller 170 in the frame memory 140, the image processor 150 detects the region, the transmittance of which is set to 100%, from the decoration image 300. When detecting the region, the transmittance of which is set to 100%, the image processor 150 determines the detected region as the superimposition region. The image processor 150 compares a size of the determined superimposition region and the size of the content image 200 and determines a reduction ratio for reducing the content image 200. The image processor 150 reduces the content image 200 at the determined reduction ratio and superimposes the reduced content image 200 on the superimposition region, the transmittance of which is set to 100%.

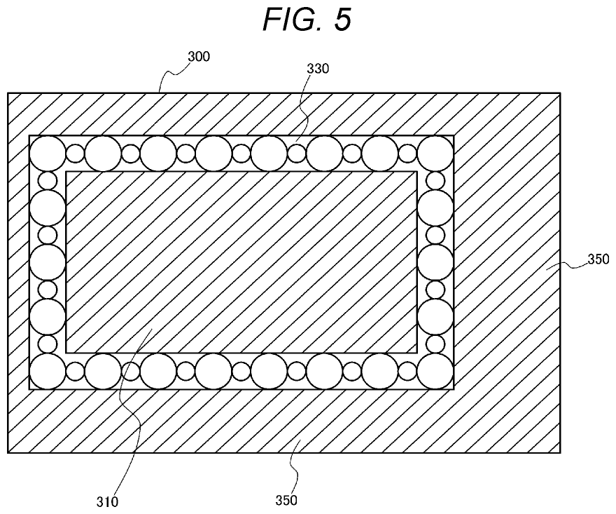

FIG. 5 is a diagram showing another example of the decoration image 300.

The size of the decoration image 300 shown in FIG. 5 is not the same as the size of the picture frame section 330 and is larger than the size of the picture frame section 330. That is, the decoration image 300 includes a region on the outer side of the picture frame section 330. The region of the decoration image 300 further on the outer side than the picture frame section 330 is referred to as background section 350.

The arrangement section 310 and the background section 350 indicated by hatching in FIG. 5 are regions formed in the specific one color such as black or regions, the transmittance of which is set to 100%. The image processor 150 detects a region, a shape of which is a rectangle and an area of which is the largest, in the regions formed in the specific one color or the regions, the transmittance of which is set to 100%.

An area of the arrangement section 310 is set larger than an area of a rectangular region that can be set in the background section 350. Therefore, the image processor 150 detects, as the arrangement section 310, a rectangular region formed in the specific one color such as black or a rectangular region, the transmittance of which is set to 100%, the region having the largest area.

When detecting the arrangement section 310, the image processor 150 compares the size of detected arrangement section 310 and the size of the content image 200 and determines a reduction ratio for reducing the content image 200. The image processor 150 reduces the content image 200 at the determined reduction ratio and superimposes the reduced content image 200 on the arrangement section 310 of the decoration image 300.

Next, the first UI image 540 for selecting the decoration image 300 is explained.

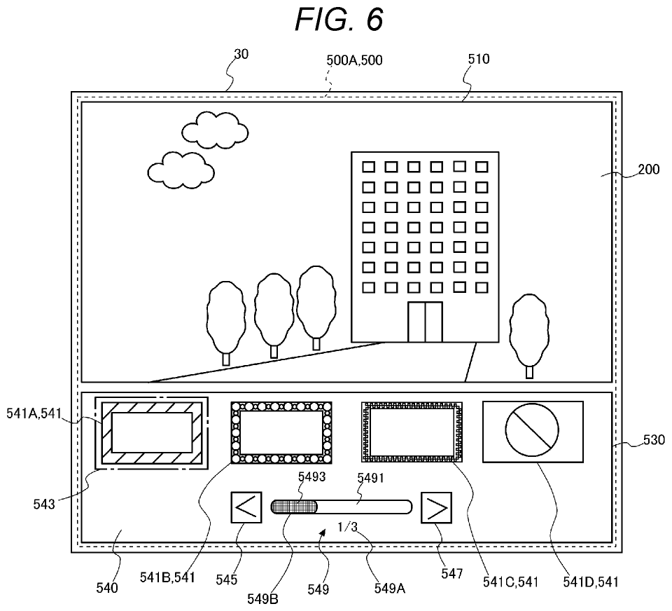

FIG. 6 is a diagram showing a projection image 500A on which the first UI image 540 is displayed. The projection image 500A is an example of the projection image 500 displayed on the screen 30 by the projector 100.

When the second change button provided in the remote controller 10 is pressed in a state in which the first mode is set as the display mode, the controller 170 causes the screen 30 to display the projection image 500A including a content region 510 and a UI region 530.

The content region 510 is a region where the combined image 400 and the content image 200 are displayed. The UI region 530 is a region where the first UI image 540 for receiving operation of the user is displayed.

The first UI image 540 displayed in the UI region 530 includes a plurality of thumbnail images 541, a selection frame 543, direction indicators 545 and 547, and screen information 549.

The thumbnail images 541 are reduced images of the plurality of decoration images 300 prepared in advance.

In FIG. 6, four thumbnail images 541A, 541B, 541C, and 541D are shown as the thumbnail images 541. Among the four thumbnail images 541, the thumbnail image 541D is an image indicating that the decoration image 300 is not combined with the content image 200.

Any two of the thumbnail images 541A, 541B, and 541C are equivalent to the first candidate image having the first exterior or the second candidate image having the second exterior different from the first exterior.

The image formed in the picture frame section 330 of the decoration image 300 is different in each of the plurality of decoration images 300. Therefore, exteriors of the plurality of decoration images 300 are different from one another. Exteriors of the thumbnail images 541 obtained by reducing the plurality of decoration images 300 are also different from one another.

The selection frame 543 is an image showing the thumbnail image 541 that is in a selected state among the plurality of thumbnail images 541 displayed on the first UI image 540. The thumbnail image 541 is displayed in the selection frame 543 to indicate that the thumbnail image 541 displayed in the selection frame 543 is in the selected state. In this embodiment, a frame-shaped image surrounding the periphery of the thumbnail image 541 is displayed as the selection frame 543. However, for example, a checkbox corresponding to each of the thumbnail images 541 may be displayed. An image having a shape other than a frame shape may be added to the selected thumbnail image 541 or the selected thumbnail image 541 itself may be highlighted by enlarged display. The selection frame 543 can also be referred to as selection cursor, focus display, and the like. A display position of the selection frame 543 in the first UI image 540 is changed by operation of the direction keys provided in the remote controller 10. The selection frame 543 is equivalent to the operation piece.

When a large number of decoration images 300 are registered, not all of the thumbnail images 541 can be displayed on one screen of the first UI image 540 in some case. In such a case, the plurality of thumbnail images 541 are displayed separately on a plurality of screens. The direction indicators 545 and 547 are operation pieces for switching and displaying the plurality of screens. For example, when a direction key in the downward direction of the remote controller 10 is pressed when the selection frame 543 is operated, one of the direction indicators 545 and 547 is selected. By operating one of the direction indicators 545 and 547, it is possible to switch and display the plurality of screens.

The direction indicator 545 is operated by pressing a direction key in the left direction or the enter key of the remote controller 10 in a state in which the direction indicator 545 is selected. A display form of the direction indicator 545 is changed when the direction indicator 545 is operated. For example, when the direction key in the left direction of the remote controller 10 is pressed, the direction indicator 545 is lit or flashed or a color of the direction indicator 545 is changed. By operating the direction indicator 545, a screen having a page number smaller than a page number of a currently displayed screen is displayed among the plurality of screens of the thumbnail images 541.

The direction indicator 547 is operated by pressing a direction key in the right direction or the enter key of the remote controller 10 in a state in which the direction indicator 547 is selected and a display form of the direction indicator 547 is changed when the display indication 547 is operated. For example, when the direction key in the right direction of the remote controller 10 is pressed, the direction indicator 547 is lit or flashed or a color of the direction 547 is changed. By operating the direction indicator 547, a screen having a larger page number than a page number of a currently displayed screen is displayed among the plurality of screens of the thumbnail images 541.

The screen information 549 includes a screen number 549A of the first UI image 540 and a slider bar 549B. The screen information 549 is information indicating a screen number of the first UI image 540 being displayed in the UI region 530. For example, when the first UI image 540 is configured from screens of three pages, information such as 1/3, 2/3, and 3/3 is displayed in the screen information 549.

The slider bar 549B includes a slider bar 5491 and a slider 5493. The slider bar 5491 indicates a range in which the slider 5493 can be moved. The slider 5493 is an image, a display position of which can be moved in a range of the slider bar 5491. For example, when a screen number of the first UI image 540 being displayed in the UI region 530 is 1/3, the slider 5493 is displayed at the left end of the slider bar 5491 on the screen 30.

When the screen number of the first UI image 540 being displayed in the UI region 530 is 2/3, the slider 5493 is displayed in the center of the slider bar 5491 on the screen 30. When the screen number of the first UI image 540 being displayed in the UI region 530 is 3/3, the slider 5493 is displayed at the right end of the slider bar 5491 on the screen 30.

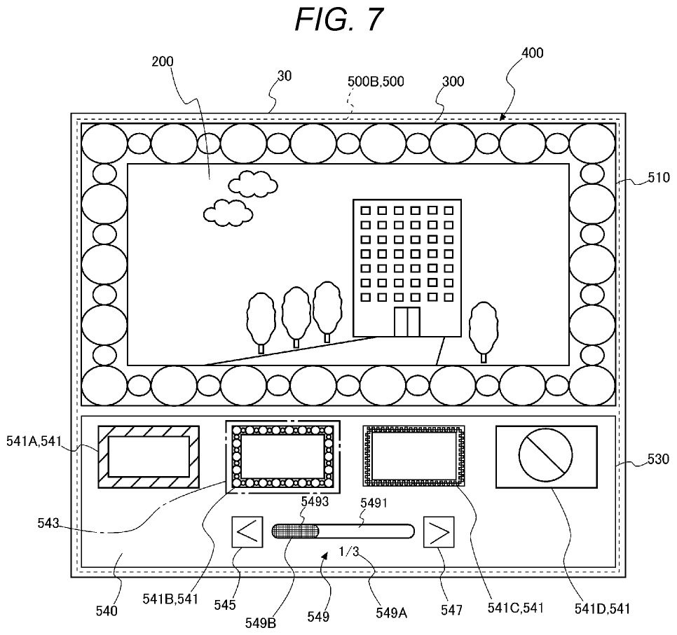

FIG. 7 is a diagram showing a projection image 500B. FIG. 7 is a diagram showing the projection image 500B in which the combined image 400 is displayed in, in particular, the content region 510. The projection image 500B is an example of the projection image 500 displayed on the screen 30 by the projector 100.

For example, when the direction key in the left direction or the direction key in the right direction of the remote controller 10 is operated when the projection image 500A shown in FIG. 6 is displayed, the controller 170 changes a display position of the selection frame 543 displayed on the first UI image 540 in a direction corresponding to the operated direction key in the left direction or the operated direction key in the right direction. The user operates the direction key in the left direction or the direction key in the right direction of the remote controller 10 such that the selection frame 543 surrounds the thumbnail image 541 that the user desires to combine with the content image 200.

Subsequently, when the enter key provided in the remote controller 10 is pressed, the controller 170 changes an image displayed in the content region 510 from the content image 200 shown in FIG. 6 to the combined image 400 shown in FIG. 7. At this time, operation for operating the direction key to change the display position of the selection frame 543 and pressing the enter key is equivalent to the operation for selecting the first candidate image. At this time, the thumbnail image 541 surrounded by the selection frame 543 is equivalent to the first candidate image. When the enter key is pressed, the controller 170 determines that the operation for selecting the first candidate image has been received. The controller 170 outputs the decoration image 300 corresponding to the thumbnail image 541 displayed in the selection frame 543 and arrangement information to the image processor 150. The image processor 150 combines, according to the arrangement information, the content image 200 with the decoration image 300 input from the controller 170 to generate the combined image 400. The image processor 150 outputs image information of the generated combined image 400 to the image projector 160. When the enter key is pressed again or an escape key is pressed, the controller 170 determines the decoration image 300 corresponding to a currently selected thumbnail image 541 as the decoration image 300 displayed in the first mode and ends the display of the first UI image 540.

Note that the controller 170 may not perform the display shown in FIG. 7. That is, when the projection image 500A shown in FIG. 6 is displayed and the enter key is pressed when the selection frame 543 surrounds any thumbnail image 541, the controller 170 may determine the decoration image 300 corresponding to the selected thumbnail image 541 as the decoration image 300 displayed in the first mode and end the display of the first UI image 540. In this case, operation for operating the direction key to change the display position of the selection frame 543 and selecting the thumbnail image 541 surrounded by the selection frame 543 is equivalent to the operation for selecting the first candidate image. At this time, the thumbnail image 541 surrounded by the selection frame 543 is equivalent to the first candidate image. When the direction key is operated, the controller 170 determines that the operation for selecting the first candidate image has been received.

When displaying the first UI image 540 on the screen 30, the controller 170 may display the combined image 400 in the content region 510 from the beginning.

For example, when displaying the first UI image 540 on the screen 30, the controller 170 displays, in the content region 510, the combined image 400 obtained by combining the decoration image 300 corresponding to the thumbnail image 541A surrounded by the selection frame 543 with the content image 200.

In an initial state, that is, before operation for moving the selection frame 543 is performed after the first UI image 540 is displayed, the controller 170 may display the selection frame 543, for example, in a preset position such as the left end among positions where the selection frame 543 can be displayed in the first UI image 540. The controller 170 may display the selection frame 543 in a position where the selection frame 543 was displayed last when the first UI image 540 was displayed last time.

Every time the selection frame 543 is moved, the controller 170 may cause the content region 510 to display the combined image 400 obtained by combining the decoration image 300 corresponding to the thumbnail image 541 present in the position of the selection frame 543 and the content image 200. Since operation for pressing the enter key can be omitted, the user can easily confirm an exterior in the case in which the selected thumbnail image 541 is combined with the content image 200. When the remote controller 10 is operated to move the display position of the selection frame 543 and the thumbnail image 541 surrounded by the selection frame 543 is changed, the controller 170 reads out the decoration image 300 corresponding to the changed thumbnail image 541 from the storage 171. The controller 170 outputs the read-out decoration image 300 and arrangement information to the image processor 150. The image processor 150 causes the content region 510 to display the combined image 400 obtained by combining the content image 200 with the decoration image 300 input from the controller 170.

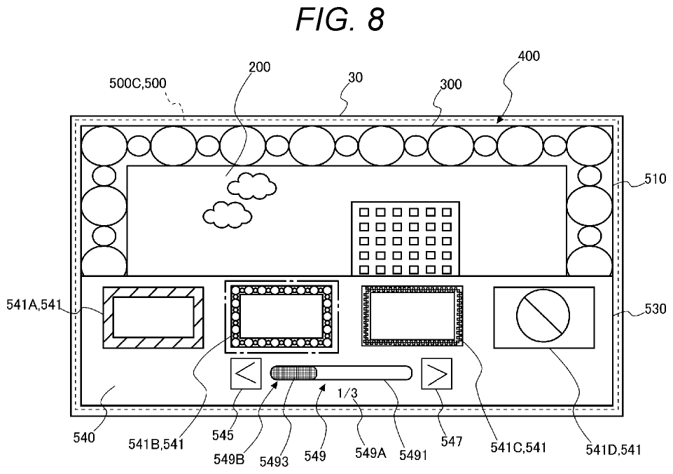

FIG. 8 is a diagram showing a projection image 500C in which a part of the UI region 530 is superimposed on the content region 510. The projection image 500C is an example of the projection image 500 displayed on the screen 30 by the projector 100.

In the projection image 500A shown in FIG. 6 and the projection image 500B shown in FIG. 7, the UI region 530 and the content region 510 are not displayed to overlap. The content region 510 is entirely displayed on the projection image 500A or 500B. In contrast, the projection image 500C shown in FIG. 8 is an image in which a part of the UI region 530 is superimposed on the content region 510 and displayed. In the projection image 500C, a part of the combined image 400 displayed in the content region 510 cannot be visually recognized but a display size of the first UI image 540 of the UI region 530 can be displayed large. Therefore, a display size of the thumbnail image 541 of the decoration image 300 can be enlarged. It is possible to improve operability of the user in selecting the decoration image 300.

The controller 170 may cause the UI region 530 to selectively display the thumbnail images 541 rather than causing in the UI region 530 to display the thumbnail images 541 of all of the decoration images 300 stored in the storage 171. For example, when supply of the content image 200 is started from the information processing device 50, the controller 170 selects the decoration image 300 in which the aspect ratio of the arrangement section 310 is the same as the aspect ratio of the supplied content image 200. The controller 170 causes the UI region 530 to display the thumbnail image 541 of the selected decoration image 300.

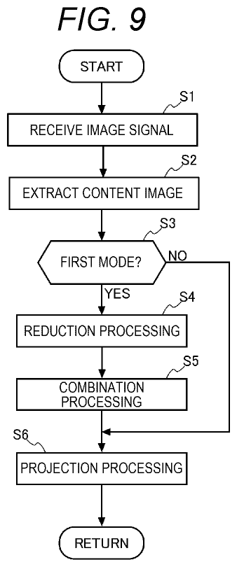

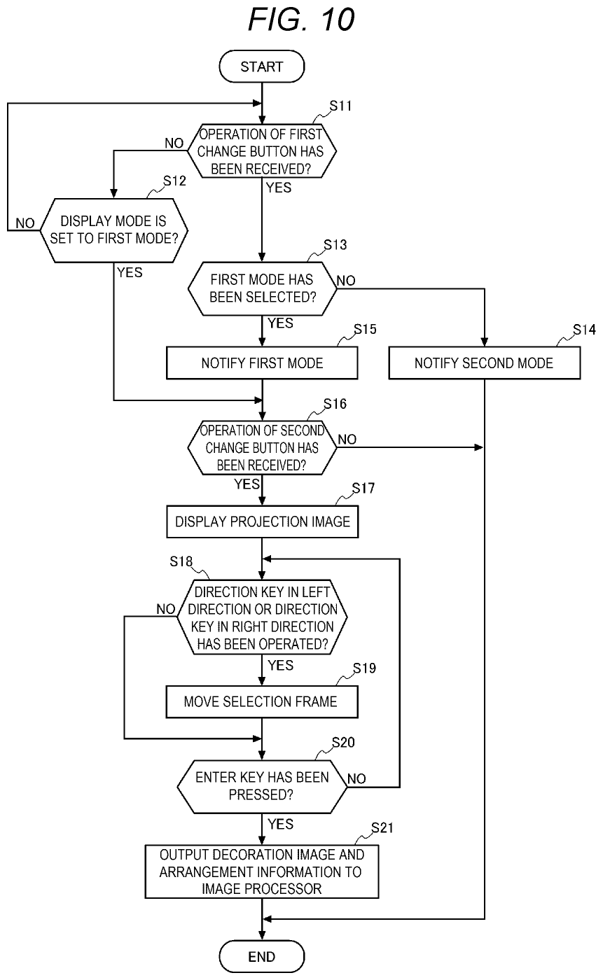

FIGS. 9 and 10 are flowcharts showing operations of the projector 100.

First, an operation of the projector 100 at the time when an image signal is received from the information processing device 50 is explained with reference to FIG. 9.

First, when receiving an image signal transmitted from the information processing device 50 via the cable 55 (step S1), the image input I/F 130 extracts the content image 200 included in the received image signal (step S2). The image input I/F 130 outputs the extracted content image 200 to the image processor 150.

The image processor 150 determines whether a display mode notified from the controller 170 is the first mode (step S3). When the display mode is the first mode (Yes in step S3), the image processor 150 executes reduction processing for reducing the content image 200 input to the image processor 150.

The image processor 150 compares the resolution of the content image 200 input from the image input I/F 130 and width and height information included in the arrangement information and calculates a reduction ratio for reducing the content image 200. When determining the reduction ratio, the image processor 150 executes the reduction processing for reducing the content image 200 at the determined reduction ratio (step S4).

Subsequently, the image processor 150 superimposes, based on the arrangement information, the content image 200 reduced by the reduction processing on the arrangement section 310 of the decoration image 300 loaded in the frame memory 140 and executes combination processing (step S5). Consequently, the combined image 400 is generated in the frame memory 140.

Subsequently, the image processor 150 reads out image information of the combined image 400 combined in the frame memory 140 and outputs the image information to the image projector 160. The image projector 160 executes projection processing based on the input image information of the combined image 400 (step S6).

When the display mode is not the first mode (NO in step S3), the image processor 150 shifts to step S6 and executes the projection processing based on the image information of the content image 200.

When the image information is input from the image processor 150, the image projector 160 starts the projection processing. When the image projector 160 starts the projection processing, the panel driver 167 applies a driving voltage corresponding to the input image information to the pixels of the image forming regions 164R, 164G, and 164B and sets the pixels to light transmittance corresponding to the image information. Light emitted from the light source 161 is separated into R, G, and B color lights by the color separation system and transmitted through the image forming regions 164R, 164G, and 164B of the liquid crystal panels 163R, 163G, and 163B. Consequently, the color lights are modulated for each of the pixels and image lights corresponding to the image information are formed for each of the color lights. The formed color image lights are combined for each of the pixels by the not-shown color combination optical system to be image light representing a color image and enlarged and projected onto the screen 30 by the projection lens 165.

Next, an operation of the projector 100 that receives operation for changing the display mode is explained with reference to the flowchart of FIG. 10.

The controller 170 determines whether operation of the first change button provided in the remote controller 10 has been received (step S11). That is, the controller 170 determines whether a change of the display mode has been requested. When operation of the first change button has not been received (NO in step S11), the controller 170 determines whether the display mode of the projector 100 is set to the first mode (step S12). When the display mode of the projector 100 is not set to the first mode (NO in step S12), the controller 170 returns to the determination in step S11.

When the display mode of the projector 100 is set to the first mode (YES in step S12), the controller 170 shifts to determination in step S16.

When receiving operation of the first change button (YES in step S11), the controller 170 determines whether the first mode has been selected as the display mode by, for example, operation of the direction key provided in the remote controller 10 (step S13). When the first mode has not been selected as the display mode (NO in step S13), the controller 170 notifies the second mode to the image processor 150 as the display mode (step S14) and ends this processing flow.

When the first mode has been selected as the display mode (YES in step S13), the controller 170 notifies the first mode to the image processor 150 as the display mode (step S15). Subsequently, the controller 170 determines whether operation of the second change button has been received (step S16). That is, the controller 170 determines whether a change of the decoration image 300 has been requested. When operation of the second change button has not been received (NO in step S16), the controller 170 ends this processing flow.

When operation of the second change button has been received (YES in step S16), the controller 170 causes the screen 30 to display the projection image 500 including the content region 510 and the UI region 530 (step S17). When the projector 100 is displaying the content image 200 on the screen 30, the content image 200 is displayed in the content region 510. The first UI image 540 is displayed in the UI region 530. The first UI image 540 includes the plurality of thumbnail images 541, the selection frame 543, the direction indicators 545 and 547, and the screen information 549.

Subsequently, the controller 170 determines whether the direction key in the left direction or the direction key in the right direction of the remote controller 10 has been operated (step S18). When the direction key in the left direction or the direction key in the right direction of the remote controller 10 has not been operated (NO in step S18), the controller 170 shifts to determination in step S20. When the direction key in the left direction or the direction key in the right direction of the remote controller 10 has been operated (YES in step S18), the controller 170 moves the selection frame 543 in the first UI image 540 in the direction corresponding to the operated direction key in the left direction or the right direction (step S19).

Subsequently, the controller 170 determines whether the enter key has been pressed (step S20). When the enter key has not been pressed (NO in step S20), the controller 170 returns to the determination in step S18. When the enter key has been pressed (YES in step S20), the controller 170 outputs the decoration image 300 corresponding to the thumbnail image 541 displayed in the selection frame 543 and arrangement information of the decoration image 300 to the image processor 150 (step S21) and ends this processing flow.

### 3. Modification 1

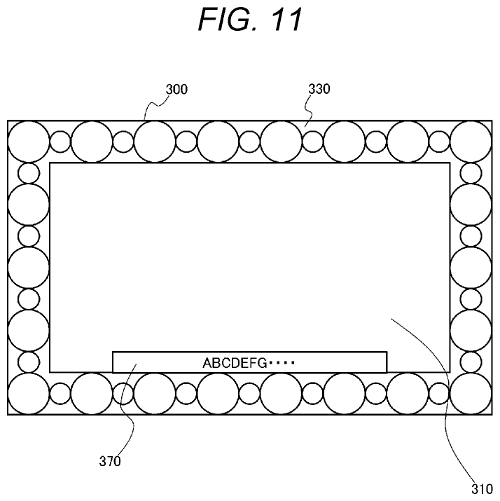

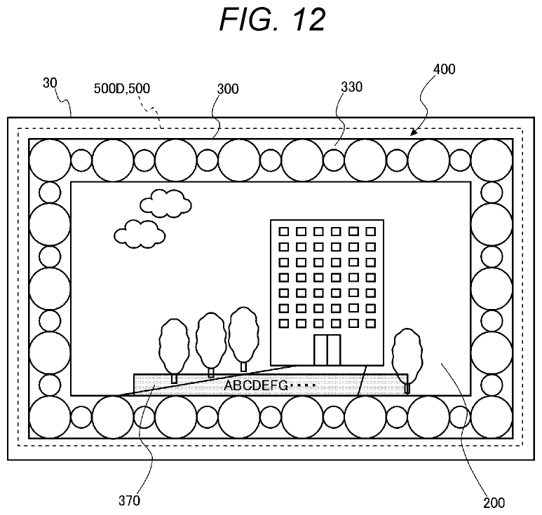

FIG. 11 is a diagram showing another example of the decoration image 300. FIG. 12 is a diagram showing a projection image 500D including the combined image 400 obtained by combining the decoration image 300 shown in FIG. 11 with the content image 200. The projection image 500D is an example of the projection image 500 displayed on the screen 30 by the projector 100.

The decoration image 300 shown in FIG. 11 includes an additional image section 370 besides the arrangement section 310 and the picture frame section 330. The additional image section 370 is equivalent to the fourth image.

The additional image section 370 is an image that decorates the content image 200 in conjunction with an image of the picture frame section 330. The additional image section 370 is arranged in the arrangement section 310. The additional image section 370 includes a setting value of transmittance and coordinate information indicating the position of the additional image section 370 in the decoration image 300. The transmittance of the additional image section 370 is higher than the transmittance of the picture frame section 330, which is the first image.

In a modification 1, the controller 170 superimposes, according to arrangement information, the content image 200 on the arrangement section 310 of the decoration image 300 loaded in the frame memory 140. Subsequently, the controller 170 superimposes the additional image section 370 having the transmittance indicated by the setting value on a coordinate of the decoration image 300 indicated by the coordinate information included in the additional image section 370. Since the additional image section 370, the transmittance of which is set to the setting value, is superimposed on the content image 200, as shown in FIG. 12, it is possible to cause a viewer to visually recognize both of the content image 200 and the additional image section 370.

### 4. Modification 2

Next, a second UI image 600 is explained. The second UI image 600 is an image for changing, according to manual operation of the user, a display position and a display size of the content image 200 and a display position and a display size of the decoration image 300 after the projection image 500 including the combined image 400 is displayed on the screen 30.

As shown in FIG. 3, an image like the picture frame section 330 is not formed in the arrangement section 310 of the decoration image 300. Therefore, if the display position of the content image 200 is changed or the display size of the content image 200 is reduced, a region where the content image 200 is not superimposed is formed. Therefore, in a modification 2, the image processor 150 copies an image of the picture frame section 330 and superimposes the copied image of the picture frame section 330 on a region of the arrangement section 310 on which the content image 200 is not superimposed.

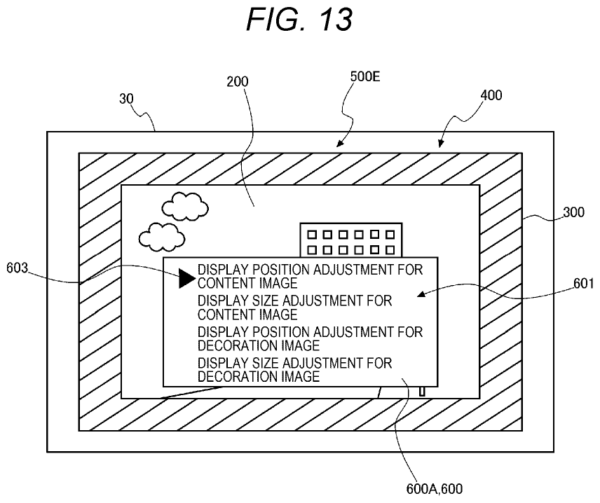

FIG. 13 is a diagram showing a projection image 500E displayed on the screen 30. FIG. 13 is a diagram showing the projection image 500E including a second UI image 600A. The projection image 500E is an example of the projection image 500 displayed on the screen 30 by the projector 100.

When the third change button provided in the remote controller 10 is pressed, the controller 170 displays the projection image 500E including the second UI image 600A shown in FIG. 13. The third change button is a button for instructing to change a display position or a display size of the content image 200 or the decoration image 300.

The second UI image 600A is an initial screen displayed first after the third change button is pressed and is a screen for selecting an image and an item to be adjusted by manual operation. The image to be adjusted is the content image 200 or the decoration image 300. The item to be adjusted is a display position or a display size. In the following explanation, the image to be adjusted is referred to as adjustment image and the item to be adjusted is referred to as adjustment item.

A display field 601 and a mark image 603 are displayed on the second UI image 600A.

A combination of adjustment images and adjustment items are displayed in the display field 601. In the display field 601 shown in FIG. 13, as the combination of the adjustment images and the adjustment items, display position adjustment for the content image 200, display size adjustment for the content image 200, display position adjustment for the decoration image 300, and display size adjustment for the decoration image 300 are displayed.

The mark image 603 is an image indicating which adjustment image and adjustment item are selected in the combination of the adjustment images and the adjustment items displayed in the display field 601.

A display position of the mark image 603 in the second UI image 600A is changed by operation of the direction keys in the upward and downward directions of the remote controller 10. The user operates the direction key in the upward direction or the direction key in the downward direction provided in the remote controller 10 and changes the mark image 603 to a display position corresponding to an adjustment image and an adjustment item desired to be selected. Thereafter, when the enter key of the remote controller 10 is pressed by the user, the controller 170 displays a second UI image 600B for operating an adjustment item corresponding to the display position of the mark image 603.

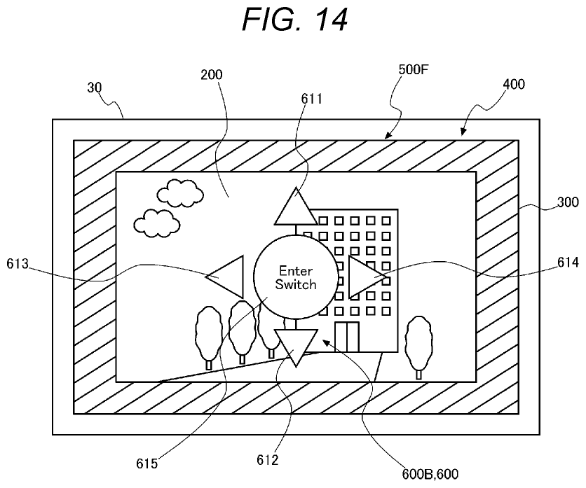

FIG. 14 is a diagram showing a projection image 500F including the second UI image 600B. The projection image 500F is an example of the projection image 500 displayed on the screen 30 by the projector 100.

The second UI image 600B includes arrow images 611, 612, 613, and 614 corresponding to the upward, downward, left, and right directions and an enter switch image 615 arranged in the center of the arrow images 611, 612, 613, and 614.

When the direction key in the upward direction provided in the remote controller 10 is pressed, a display form of the arrow image 611 is changed to a form different from a display form of the other arrow images 612, 613, and 614. For example, the arrow image 611 is lit or flashed. The arrow image 611 is displayed in a color different from a display color of the other arrow images 612, 613, and 614. When the enter key provided in the remote controller 10 is pressed, a display form of the enter switch image 615 is changed to a form different from a display form of the arrow images 611, 612, 613, and 614.

When the direction key in the downward direction provided in the remote controller 10 is pressed, a display form of the arrow image 612 is changed to a form different from a display form of the other arrow images 611, 613, and 614.

When the direction key in the left direction provided in the remote controller 10 is pressed, a display form of the arrow image 613 is changed to a form different from a display form of the other arrow images 611, 612, and 614.

When the direction key in the right direction provided in the remote controller 10 is pressed, a display form of the arrow image 614 is changed to a form different from a display form of the other arrow images 611, 612, and 613.

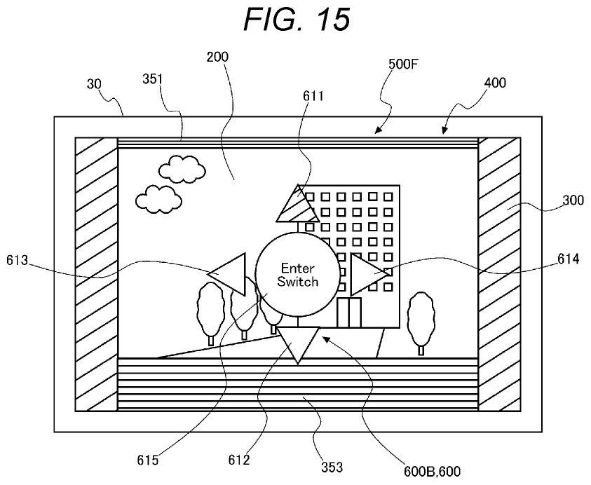

FIG. 15 is a diagram showing the projection image 500F in which a display position of the content image 200 is moved in the upward direction toward the screen 30.

For example, it is assumed that, in the second UI image 600A, the display position adjustment for the content image 200 is selected as an adjustment image and an adjustment item. When the direction key in the upward direction provided in the remote controller 10 is pressed, the controller 170 lights or flashes the arrow image 611. Subsequently, the controller 170 instructs, in the frame memory 140, to the image processor 150, a movement amount and a moving direction for moving the content image 200.

The picture frame section 330 located in an upper part of the content image 200 is referred to as upper picture frame section 351. The picture frame section 330 located in a lower part of the content image 200 is referred to as lower picture frame section 353. In FIG. 15, lateral lines are shown with the upper picture frame section 351 and the lower picture frame section 353 added thereto in order to distinguish the upper picture frame section 351 and the lower picture frame section 353 from the other picture frame section 330.

In a drawing view, the display position of the content image 200 is moved upward, whereby the area of the upper picture frame section 351 becomes smaller than the area before the movement of the content image 200 and the area of the lower picture frame section 353 becomes larger than the area before the movement of the content image 200.

When the movement amount and the moving direction are instructed from the controller 170, the image processor 150 superimposes, based on the instruction, before the movement of the content image 200, the content image 200 on a region of the upper picture frame section 351 of the frame memory 140 in which the picture frame section 330 is loaded. The image processor 150 copies an image of the picture frame section 330 and, before the movement of the content image 200, superimposes the copied image of the picture frame section 330 on a region of the lower picture frame section 353 of the frame memory 140 in which the content image 200 is loaded.

Consequently, a display position of the content image 200 in the projection image 500F displayed on the screen 30 moves in the upward direction toward the screen 30.

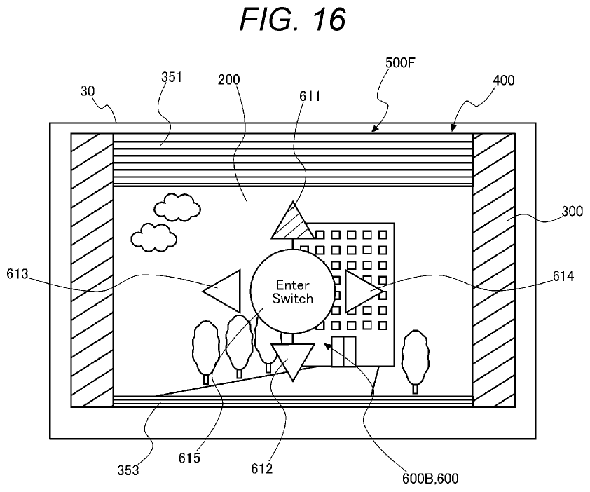

FIG. 16 is a diagram showing the projection image 500F in which a display position of the decoration image 300 is moved in the upward direction toward the screen 30.

For example, it is assumed that, in the second UI image 600A, the display position adjustment for the decoration image 300 is selected as an adjustment image and an adjustment item. When the direction key in the upward direction provided in the remote controller 10 is pressed, the controller 170 lights or flashes the arrow image 611. Subsequently, the controller 170 instructs, in the frame memory 140, to the image processor 150, a movement amount and a moving direction for moving the decoration image 300.

In a drawing view, the display position of the decoration image 300 is moved upward, whereby the area of the upper picture frame section 351 becomes larger than the area before the movement of the decoration image 300 and the area of the lower picture frame section 353 becomes smaller than the area before the movement of the decoration image 300.

When the movement amount and the moving direction are instructed from the controller 170, based on the instruction, the image processor 150 copies an image of the picture frame section 330 and superimposes the copied image of the picture frame section 330 on a region of the frame memory 140 that becomes the upper picture frame section 351 anew.

Before the movement of the decoration image 300, the image processor 150 erases an image from a region of the lower picture frame section 353 of the frame memory 140 in which an image of the picture frame section 330 is loaded. Consequently, the display position of the decoration image 300 in the projection image 500F displayed on the screen 30 moves in the upward direction toward the screen 30.

In the explanation referring to FIGS. 15 and 16, when the enter key of the remote controller 10 is pressed after any one of the upward, downward, left, and right direction keys of the remote controller 10 is pressed, the image processor 150 may start to change the display position of the content image 200 or the decoration image 300. The image processor 150 changes the display position of the content image 200 or the decoration image 300 in a direction corresponding to the operated one of the upward, downward, left, and right direction keys of the remote controller 10 until the enter key of the remote controller 10 is pressed again.

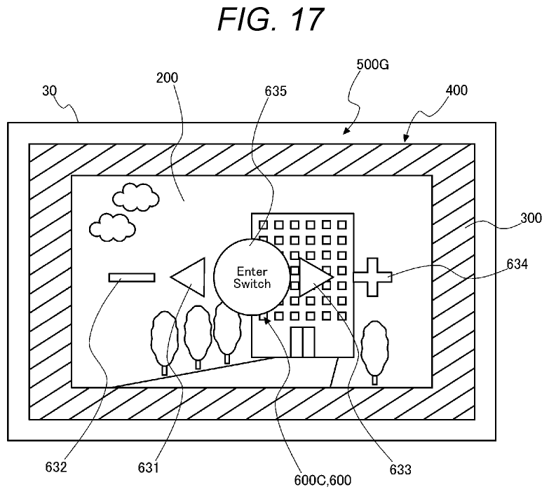

FIG. 17 is a diagram showing a projection image 500G including a second UI image 600C for adjusting a display size of the content image 200 or the decoration image 300. The projection image 500G is an example of the projection image 500 displayed on the screen 30 by the projector 100.

The second UI image 600C includes an arrow image 631 corresponding to the left direction, an arrow image 633 corresponding to the right direction, and an enter switch image 635 arranged between the arrow images 631 and 633. The second UI image 600C includes a minus indicator image 632 displayed on the left side of the arrow image 631 on the screen 30 and a plus indicator image 634 displayed on the right side of the arrow image 633 on the screen 30. The minus indicator image 632 is an image indicating that the display size of the content image 200 or the decoration image 300 is reduced by pressing the direction key in the left direction provided in the remote controller 10. The plus indicator image 634 is an image indicating that the display size of the content image 200 or the decoration image 300 is enlarged by pressing the direction key in the right direction provided in the remote controller 10.

When the direction key in the left direction provided in the remote controller 10 is pressed, a display form of the arrow image 631 is changed to a form different from a display form of the arrow image 633. For example, the arrow image 631 is lit or flashed. The arrow image 631 is displayed in a color different from a display color of the arrow image 633.

When the enter key provided in the remote controller 10 is pressed, a display form of the enter switch image 635 is changed to a form different from a display form of the arrow images 631 and 633.

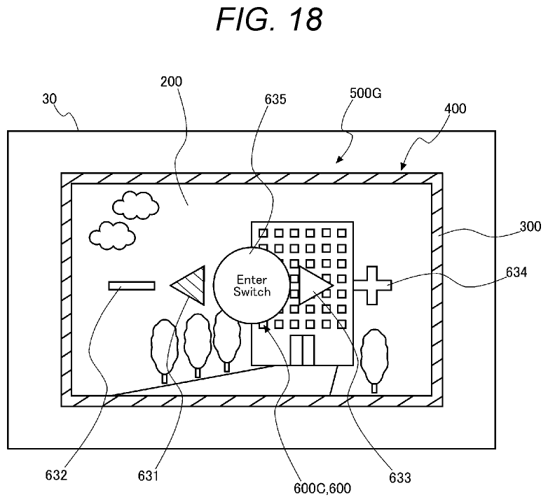

FIG. 18 is a diagram showing the projection image 500G in which a display size of the decoration image 300 is reduced.

For example, it is assumed that, in the second UI image 600A, the display size adjustment for the decoration image 300 is selected as an adjustment image and an adjustment item. When the direction key in the left direction provided in the remote controller 10 is pressed, the controller 170 lights or flashes the arrow image 631. Subsequently, the controller 170 reduces the display size of the decoration image 300 to be smaller than the display size before the pressing of the direction key in the left direction. The controller 170 instructs a reduction ratio for reducing the display size of the decoration image 300 to the image processor 150.

The image processor 150 reduces the display size of the decoration image 300 according to the reduction ratio input from the controller 170 and loads the reduced decoration image 300 in the frame memory 140. At this time, the image processor 150 loads the decoration image 300 in the frame memory 140 such that deviation does not occur between the centers in the S-axis direction and the T-axis direction of the decoration image 300 before the reduction and the centers in the S-axis direction and the T-axis direction of the decoration image 300 after the reduction.

Subsequently, the 150 image processor superimposes the content image 200 on a coordinate of the frame memory 140 on which the content image 200 was superimposed before the display size of the decoration image 300 was reduced. Consequently, the display size of the decoration image 300 included in the projection image 500G is reduced.

When the direction key in the right direction provided in the remote controller 10 is pressed, a display form of the arrow image 633 is changed to a form different from a display form of the arrow image 631. For example, the arrow image 633 is lit or flashed. The arrow image 633 is displayed in a color different from a display color of the arrow image 631.

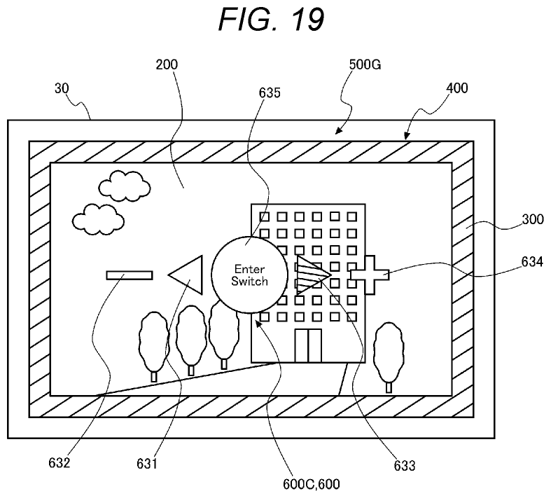

FIG. 19 is a diagram showing the projection image 500G in which a display size of the content image 200 is enlarged.

For example, it is assumed that, in the second UI image 600A, the display size adjustment for the content image 200 is selected as an adjustment image and an adjustment item. When the direction key in the right direction provided in the remote controller 10 is pressed, the controller 170 lights or flashes the arrow image 633. Subsequently, the controller 170 enlarges the display size of the content image 200 to be larger than the display size before the pressing of the direction key in the right direction. The controller 170 instructs the image processor 150 an enlargement ratio for enlarging the display size of the content image 200.

The image processor 150 enlarges the display size of the content image 200 according to the enlargement ratio input from the controller 170 and loads the enlarged content image 200 in the frame memory 140. At this time, the image processor 150 loads the decoration image 300 in the frame memory 140 such that deviation does not occur between the centers in the S-axis direction and the T-axis direction of the content image 200 before the enlargement and the centers in the S-axis direction and the T-axis direction of the content image 200 after the enlargement. Since the display size of the content image 200 is enlarged, the content image 200 is superimposed on the frame memory 140 in which the decoration image 300 is already written. The image processor 150 superimposes the content image 200 on a region of the frame memory 140 in which the decoration image 300 is already written. Consequently, the display size of the content image 200 included in the projection image 500G is enlarged.

In the explanation referring to FIGS. 18 and 19, when the enter key of the remote controller 10 is pressed after the left or right direction key of the remote controller 10 is pressed, the image processor 150 may start to enlarge or reduce the display size of the content image 200 or the decoration image 300.

The image processor 150 enlarges or reduces the display size of the content image 200 or the decoration image 300 drawn in the liquid crystal panels 163 until the enter key of the remote controller 10 is pressed again.

### 5. Other Embodiments

The embodiment explained above is a preferred mode of implementation. However, the present disclosure is not limited to the embodiment explained above and various modified implementations are possible within a range not departing from the gist of the present disclosure.

For example, in the embodiment explained above, the controller 170 of the projector 100 executes the first mode and the second mode.

As another example, an application program installed in the information processing device 50 may execute the first mode and the second mode to generate an image supplied to the projector 100.

When the first mode is selected as the display mode, the information processing device 50 combines the decoration image 300 with the content image 200 to generate the combined image 400. The information processing device 50 transmits an image signal including the generated combined image 400 to the projector 100. When the second mode is selected as the display mode, the information processing device 50 transmits an image signal including the content image 200 to the projector 100.

The information processing device 50 may display the various UI images in the embodiment explained above and receive operation. In this case, the information processing device 50 may transmit information for generating the projection image 500 to the projector 100. For example, the information processing device 50 may transmit information for selecting the first mode or the second mode and information indicating the selected decoration image 300 to the projector 100. When a smartphone is used as the remote controller 10, the smartphone may execute the same function.

In this embodiment, the projector 100 includes the three transmissive liquid crystal panels 163 as the light modulation device. However, embodiments of the present disclosure are not limited to this. The light modulation device may be a reflective liquid crystal panel or may be a digital micro mirror device. The number of display panels included in the light modulation device is not limited and may be, for example, one.

The functional units shown in FIG. 1 indicate functional components and specific implementation forms of the functional units are not particularly limited. That is, hardware individually corresponding to the functional units does not always need to be implemented. It is naturally possible that one processor executes a program to implement functions of a plurality of functional units. A part of functions implemented by software in the embodiment may be implemented by hardware or a part of functions implemented by hardware in the embodiment may be implemented by software.

When a projection method and a non-transitory computer-readable storage medium storing a program are implemented using a computer included in the projector 100, a program to be executed by the computer can also be configured in a form of a recording medium or a transmission medium for transmitting the program. A magnetic or optical recording medium or a semiconductor memory device can be used as the recording medium. Specifically, examples of the recording medium include portable or stationary recording media such as a flexible disk, a HDD (Hard Disk Drive), a CD-ROM, a DVD, a Blu-ray Disc, a magneto-optical disk, a flash memory, and a card-type recording medium. The recording medium may be a nonvolatile storage device such as a RAM, a ROM, or a HDD, which is an internal storage device included in a server device. Blu-ray is a registered trademark.

In the embodiment explained above, an example is explained in which the content image 200 is superimposed on the decoration image 300. However, the decoration image 300 may be superimposed on the content image 200.

If values of a coordinate, a size, and the like are known, the content image 200 can be loaded in the frame memory 140 first. In this case, the transmittance of the arrangement section 310 is desirably set to 100%. When the additional image section 370, which is the fourth image, is present, the decoration image 300 attached with the additional image section 370 only has to be placed on the content image 200 if the content image 200 is placed under the additional image section 370.

### 6. Summary of the Present Disclosure

A summary of the present disclosure is noted below.

### Note 1

A projector including: an optical device; and at least one processor, wherein the at least one processor operates in a first mode for controlling the optical device to thereby project a third image including a first image having a first size and a second image arranged along a contour of the first image on an outer side of the first image and a second mode for controlling the optical device to thereby project the first image in a second size larger than the first size.

With this configuration, it is possible to switch and project the first image and the third image including the first image and the second image. Therefore, it is possible to increase flexibility of an image to be projected and improve convenience of a user.

### Note 2

The projector described in Note 1, wherein the at least one processor may project the third image in the second size in the first mode.

With this configuration, it is possible to project, in the first mode, the third image having the second size that is the same as a size of the first image projected in the second mode. Therefore, it is possible to change the size of the first image by switching the first mode and the second mode. It is possible to improve flexibility of the first image.

### Note 3

The projector described in Note 1 or 2, wherein the at least one processor may project the third image in the first mode such that the first image and the second image do not overlap.

With this configuration, the first image and the second image do not overlap in the projected third image. Therefore, it is possible to prevent a state in which a part of the first image or the second image included in the third image is not projected.

### Note 4

The projector described in any one of Notes 1 to 3, wherein the third image may include a first region where the first image is arranged and a second region where the second image is arranged, and, when a first aspect ratio of the first region and a second aspect ratio of the first image are different, the at least one processor may project the third image including the first image having the second aspect ratio.

With this configuration, when the first aspect ratio of the first region and the second aspect ratio of the first image are different, the third image including the first image having the second aspect ratio is projected. Since an aspect ratio of the first image is maintained at the second aspect ratio, it is possible to satisfactorily keep the exterior of the first image compared with when the aspect ratio of the first image is changed to the first aspect ratio.

### Note 5

The projector described in any one of Notes 1 to 3, wherein the third image may include a first region where the first image is arranged and a second region where the second image is arranged, and, when a first aspect ratio of the first region and a second aspect ratio of the first image are different, the at least one processor may project the third image including the first image having the first aspect ratio.

With this configuration, when the first aspect ratio of the first region and the second aspect ratio of the first image are different, the third image including the first image having the first aspect ratio is projected. Therefore, it is possible to project the third image including the first image having an aspect ratio changed to the first aspect ratio of the first region. Therefore, for example, a margin in which the first image is not displayed is less easily formed in the first region.

### Note 6

The projector described in any one of Notes 1 to 5, wherein the optical device may include at least one display panel, and a size of the third image may be smaller than a maximum size in which an image can be drawn on the at least one display panel.

With this configuration, since the size of the third image is smaller than the maximum size in which an image can be drawn on the display panel, it is possible to change a position, a shape, and a size of the third image drawn on the display panel. Therefore, it is possible to increase flexibility of the third image to be projected and improve convenience of the user.

### Note 7

The projector described in any one of Notes 1 to 6, wherein the at least one processor may further execute controlling the optical device to thereby project a user interface image including a first candidate image having a first exterior and a second candidate image having a second exterior different from the first exterior and, when receiving, with the user interface image, operation for selecting the first candidate image, project an image corresponding to the first candidate image as the second image in the first mode.

With this configuration, since the operation for selecting the first candidate image is received by the user interface image, s possible to project the image corresponding to the first candidate image as the second image in the first mode. Therefore, by operating the user interface image, it is possible to select an image to be projected. It is possible to improve the convenience of the user.

### Note 8

The projector described in Note 7, wherein the user interface image may include an operation piece, a display position of which is changed by operation of a user, and, when the operation piece is superimposed on the first candidate image, the at least one processor may project the third image including the image corresponding to the first candidate image as the second image.

With this configuration, since the operation piece, the display position of which is changed by the operation of the user, is superimposed on the first candidate image, the third image including the image corresponding to the first candidate image as the second image is projected. Therefore, it is possible to select the second image included in the third image by operating the operation piece. It is possible to improve the convenience of the user.

### Note 9

The projector described in any one of Notes 1 to 8, wherein the at least one processor may control the optical device to thereby project the third image further including a fourth image superimposed on the first image and having transmittance higher than transmittance of the first image.

With this configuration, it is possible to project the third image including the fourth image having the transmittance higher than the transmittance of the first image. Therefore, it is possible to add the fourth image having the transmittance higher than the transmittance of the first image to the third image. It is possible to increase flexibility of an image to be projected and improve the convenience of the user.

### Note 10

The projector described in Note 7 or 8, wherein the third image may include a first region where the first image is arranged and a second region where the second image is arranged, and the at least one processor may project the user interface image including the first candidate image and the second candidate image in which a first aspect ratio of the first region coincides with a second aspect ratio of the first image.

With this configuration, it is possible to project the user interface image including the first candidate image and the second candidate image, an aspect ratio of which coincides with the second aspect ratio of the first image. Therefore, even if a mode is changed from the first mode to the second mode, it is possible to prevent the aspect ratio of the first image to be projected from being changed.

### Note 11

A projection method including: projecting, in a first mode, a third image including a first image having a first size and a second image arranged along a contour of the first image on an outer side of the first image; and projecting, in a second mode, the first image in a second size larger than the first size.

With this configuration, it is possible to switch and project the first image and the third image including the first image and the second image. Therefore, it is possible to increase flexibility of an image to be projected and improve convenience of a user.

### Note 12

A non-transitory computer-readable storage medium storing a program, the program causing a computer to execute: projecting, in a first mode, a third image including a first image having a first size and a second image arranged along a contour of the first image on an outer side of the first image; and projecting, in a second mode, the first image in a second size larger than the first size.

With this configuration, it is possible to switch and project the first image and the third image including the first image and the second image. Therefore, it is possible to increase flexibility of an image to be projected and improve convenience of a user.

What is claimed is:

1. A projector comprising:
an optical device; and
at least one processor programmed to operate in
a first mode for controlling the optical device to thereby project a third image including a first image having a first size and a second image arranged along a contour of the first image on an outer side of the first image, and
a second mode for controlling the optical device to thereby project the first image in a second size larger than the first size.

2. The projector according to claim 1, wherein the at least one processor programmed to project the third image in the second size in the first mode.

3. The projector according to claim 1, wherein the first image and the second image do not overlap in the first mode.

4. The projector according to claim 3, wherein
the third image includes a first region where the first image is arranged and a second region where the second image is arranged, and
when a first aspect ratio of the first region and a second aspect ratio of the first image are different, the at least one processor programmed to project the third image including the first image having the second aspect ratio.

5. The projector according to claim 3, wherein
the third image includes a first region where the first image is arranged and a second region where the second image is arranged, and
when a first aspect ratio of the first region and a second aspect ratio of the first image are different, the at least one processor projects the third image including the first image having the first aspect ratio.

6. The projector according to claim 1, wherein
the optical device includes at least one display panel, and
a size of the third image is smaller than a maximum size in which an image can be drawn on the at least one display panel.

7. The projector according to claim 1, wherein
the at least one processor further programmed to execute controlling the optical device to thereby project a user interface image including a first candidate image having a first exterior and a second candidate image having a second exterior different from the first exterior and,
when receiving, with the user interface image, operation for selecting the first candidate image, projects an image corresponding to the first candidate image as the second image in the first mode.

8. The projector according to claim 7, wherein
the user interface image includes an operation piece, a display position of which is changed by operation of a user, and
when the operation piece is superimposed on the first candidate image, the at least one processor projects the third image including the image corresponding to the first candidate image as the second image.

9. The projector according to claim 1, wherein the at least one processor programmed to control the optical device to thereby project the third image further including a fourth image superimposed on the first image and having transmittance higher than transmittance of the first image.

10. The projector according to claim 7, wherein
the third image includes a first region where the first image is arranged and a second region where the second image is arranged, and
the user interface image includes the first candidate image and the second candidate image in which a first aspect ratio of the first region coincides with a second aspect ratio of the first image.

11. A projection method comprising:
projecting, in a first mode, a third image including a first image having a first size and a second image arranged along a contour of the first image on an outer side of the first image; and
projecting, in a second mode, the first image in a second size larger than the first size.

12. A non-transitory computer-readable storage medium storing a program, the program causing a computer to execute:
projecting, in a first mode, a third image including a first image having a first size and a second image arranged along a contour of the first image on an outer side of the first image; and
projecting, in a second mode, the first image in a second size larger than the first size.
